(19) United States
(12) Patent Application Publication
(10) Pub. No.: US 2006/0026022 A1
(43) Pub. Date: Feb. 2, 2006

(54) Method of performing a product transaction where an owner permits a user to use a product without regard for the creditworthiness of the user

(76) Inventors: Donald Ray Cooley JR., Portland, OR (US); Dhryl Anton, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/133,638

(22) Filed: May 20, 2005

Related U.S. Application Data
(60) Provisional application No. 60/598,751, filed on Aug. 2, 2004.

(51) Int. Cl. G06Q 99/00

(52) U.S. Cl. 705/1

(57) ABSTRACT

A method of performing a product transaction where an owner permits a user to use a product without regard for the creditworthiness of the user. The method includes the step of providing the product to the user by requiring the user to perform at least one preselected task without any regard at any time for the creditworthiness of the user. Also included is the step of preventing the user from using the product if the user does not perform the at least one preselected task. The preventing step is also performed by using a product-control mechanism that allows the owner to remotely control the product if the user does not perform the at least one preselected task. A product-control mechanism is also used to allow the owner to block operation of the product by the requestor.

### CROSS-REFERENCE TO RELATED APPLICATIONS

This application claims priority under 35 U.S.C. § 119(e) to U.S. Provisional Patent Application Ser. No. 60/598,751, filed Aug. 2, 2004 and entitled “System and Method for Tracking and Controlling a Rented Item”, which is incorporated herein by reference.

### TECHNICAL FIELD

The field of the invention relates to systems and methods for renting, leasing and selling products.

### BACKGROUND

Conventional transactions in which consumers purchase, rent or lease products involves a credit-approval process as a condition of the transaction. The seller, renter or lessor investigates the potential consumer's credit and agrees to sell, rent or lease the product based upon that determination.

The present invention includes a system and method for selling, renting or leasing a product without any regard for the creditworthiness of the product consumer.

### SUMMARY OF THE INVENTION

The invention may be characterized as a method of performing a product transaction where an owner permits a user to use a product without regard for the creditworthiness of the user. The method includes the step of providing the product to the user by requiring the user to perform at least one preselected task without any regard at any time for the creditworthiness of the user. Also included is the step of preventing the user from using the product if the user does not perform the at least one preselected task.

The preventing step is also performed by using a product-control mechanism that allows the owner to remotely control the product if the user does not perform the at least one preselected task. A product-control mechanism is also used to allow the owner to block operation of the product by the requester.

### BRIEF DESCRIPTION OF THE DRAWINGS

FIG. 1 is a schematic block diagram showing a version of the method of the invention.

FIG. 2 is a schematic block diagram showing another version of the method of the invention.

FIG. 3 is a schematic block diagram showing a version of the system of the invention.

FIG. 4 is a schematic block diagram showing another version of the system of the invention.

FIG. 5 is a schematic block diagram showing another version of the method of the invention.

FIG. 6 is a schematic block diagram showing another version of the system of the invention.

FIG. 7 is an isometric view of a product with a product-control mechanism used with and included in the method and system of the invention.

### DETAILED DESCRIPTION

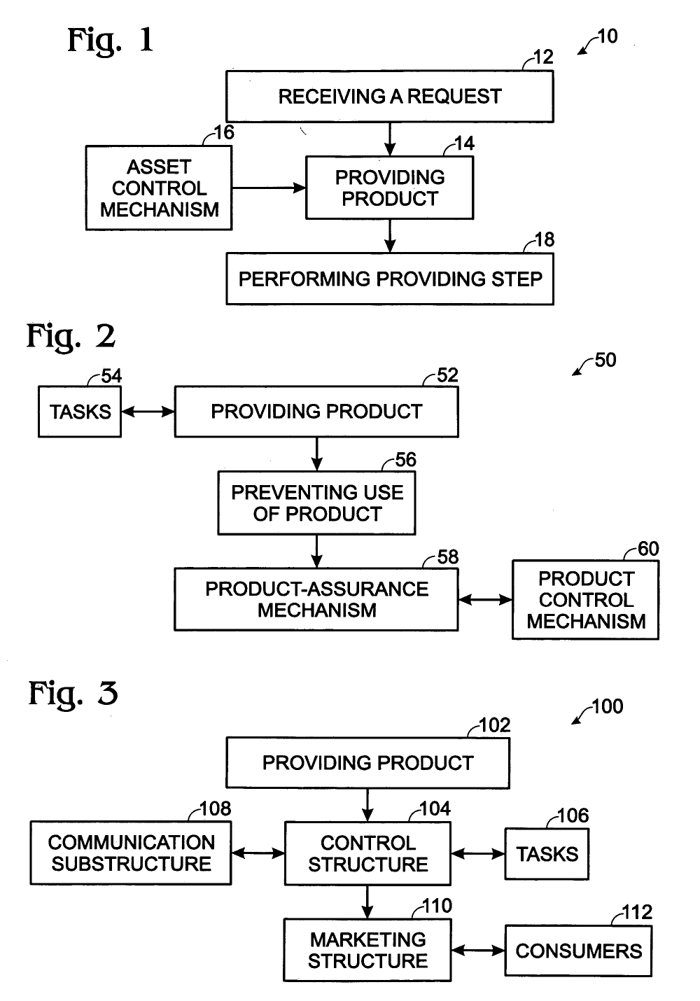

Referring to FIG. 1, there is shown a method 10 of allowing an owner to permit use of a product by a requestor regardless of creditworthiness. A first step 12 involves receiving a request from a requester, followed by a second step 14 of providing the product to the requestor. The providing step is done by requiring the requestor to agree to perform preselected tasks required by the owner, and by preventing the requestor from using the product if the requestor does not perform at least one of the preselected tasks. The preselected tasks may include monthly payment obligations to the owner, as well as maintaining product insurance. The idea is for the owner to require tasks that are pertinent to the permitted use of the product.

Still referring to FIG. 1, the preventing step is performed by using an asset-control mechanism 16 that allows the owner to control the product if the requestor does not perform at least one of the preselected tasks. Method 10 also includes step 18 of performing providing step 14 without any regard for the creditworthiness of the requestor.

The asset-control mechanism may include any mechanism that can be controlled remotely or by a timing-control device, and that can be suitably coupled to the product to prevent an individual (such as a requestor, renter, lessee, purchaser) from using it. Suitable coupling of such a mechanism may include coupling to an operational component, such as an actuator, lock mechanism, ignition, motor/engine-related controls, or any other component the disabling of which would render the product useless to the consumer.

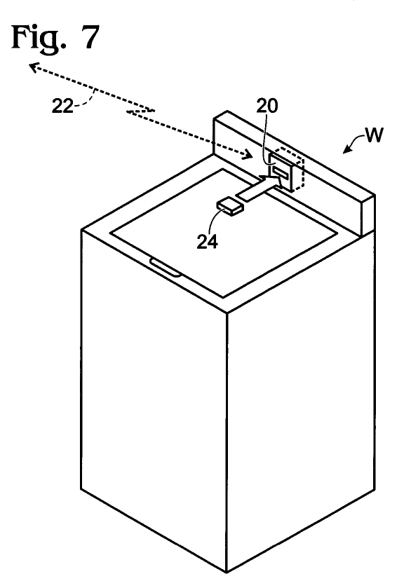

Referring ahead for a moment to FIG. 7, there is shown a product (such as a washing machine) W which includes one version of asset-control mechanism 16 as a control device 20. That control device is constructed to afford two-way communication (shown schematically by the double-arrowed line 22) between the device and the owner of the product. Also shown is portable communication device 24 which may take the form of a card. The idea is for the requester to possess the card and use it by inserting it into control device 20, allowing the requestor to use product W. The card is one example of several proposed by this invention. Other forms of device 24 (undepicted) may be: (i) a biometric device or other suitable customer identifier (in which the customer presses their thumb on a pad located on control device 20, which is constructed to read the impression of the customer's thumbprint left on the pad and determine whether the customer is an authorized user of product W); or (ii) a keypad device located on and in communication with control device 20, allowing the customer to enter a password/personal-identifier code. By using communication device 24, the invented system and method can verify that the customer is an authorized customer on an ongoing basis. For example, if the customer does not meet a fourth monthly payment obligation after meeting the first three, authorization can be withdrawn immediately and the customer will no longer be able to use the product. The mechanism to accomplish this is to withdraw that customer authorization so that control device 20 will not respond when the customer uses the communication device to begin operating the automobile. The product owner is in communication with control device 20 via the two-way communication shown by arrow 22.

The idea behind FIG. 7 is to show that asset-control mechanism 16 may be placed in various locations within product W to meet the functional requirements of being suitably coupled to product W so that it can prevent the requestor from using the product. That coupling may take the form of communication with the product-locking system (so that the requestor may not enter), or communication with other operational components of the product (so that the requestor may not operate or use the product).

Referring now to FIG. 2, another version of the invention is shown by a method 50 of assuring that a product is being used by an authorized user. The method includes a step 52 of providing the product to the authorized user. That step is performed by requiring the user to agree to perform at least one preselected task without any regard at any time for the creditworthiness of the user. Another step 56 involves preventing the user from using the product if the user does not perform the at least one preselected task. The concept of tasks is shown schematically at box 54, and those tasks may include payment obligations, product insurance obligations, and others as described above in connection with the first version of the invention.

Still referring to FIG. 2, the preventive step is performed by using product-assurance mechanism 58 and a product-control mechanism 60. Mechanism 58 allows the owner to remotely control the product if the user does not perform the at least one preselected tasks. Mechanism 60 allows the owner to block operation of the product by the requester. Blocking operation may include locking the product doors so that the user cannot enter, locking the product wheels so that the user cannot drive the product, and disabling the product ignition or other motor/engine-related control mechanism so that the user cannot start or use the product motor/engine.

Referring now to FIG. 3, there is shown a product marketing system 100 that allows a marketer to market products to consumers. System 100 includes a supply 102 of products and control structure 104 coupled to each of the products. A series of tasks shown schematically at 106, and communication substructure 108 are involved with control structure 104 and will be described further after completing this general description. System 100 also includes marketing structure 110 designed to communicate to consumers (shown schematically at 112) about the products and about how a consumer can obtain access to a desired one of the products without regard to the creditworthiness of the consumer.

Still referring to FIG. 3, control structure 104 allows the marketer to control access to a desired product by a consumer. Control structure 104 also allows the marketer to control access to that product based upon whether the consumer performs certain preselected, required tasks 106, such as the tasks defined above. Control structure 104 also includes communications substructure 108 allowing the marketer and consumer to communicate with each other after the consumer has obtained access to the product. That communication may include exchange of any information that is pertinent to the product transaction, including payment by the consumer to the marketer to meet the consumer's monthly payment obligation.

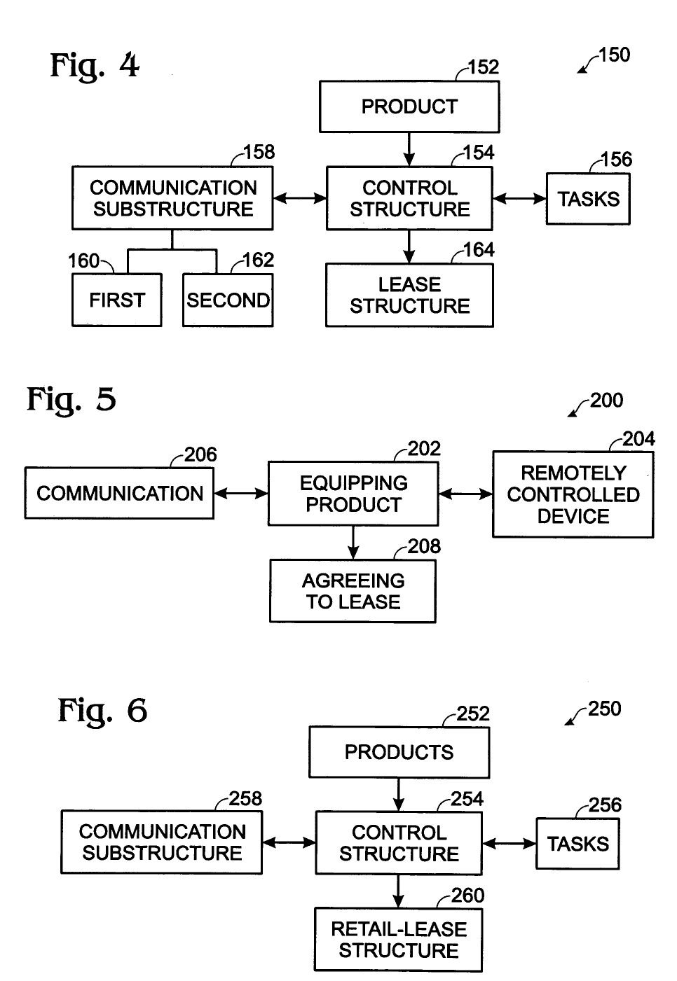

Referring to FIG. 4, the invention may also be characterized as a product lease system 150 that includes a supply 152 of products, and control structure 154 coupled to each of the products. Box 156 schematically illustrates certain tasks to be performed by product lessees, and control structure 154 also includes communication substructure 158. That communication substructure may include first-communication substructure 160 and second-communication substructure 162. First-communication substructure 160 allows the lessor and lessee to communication with each other after the lessee has leased the product. Second-communication substructure 162 allows the lessor to communicate with the product, such as by unlocking the door of the product to enter it.

Still referring to FIG. 4, product lease system 150 also includes lease structure 164 which may take the form of printed or electronic material that defines the lease relationship, and among other things, the number of tasks 156 that the lessee must perform to meet the obligations of lease structure 164.

Referring to FIG. 5, the invention may also be characterized as a method 200 of leasing a product from a lessor to a lessee. That method includes step 202 of equipping a product with a remotely controlled device 204 that can be used to control the product. The concept of communication between the lessor and lessee is shown schematically at box 206, which box is meant to signify that the equipping step also includes use of a communicator to allow the lessor and lessee to communicate with each other after the lessee has leased the product. Method 200 also includes step 208 of agreeing to lease the product to the lessee without regard to the creditworthiness of the lessee.

Referring to FIG. 6, a retail-product leasing system 250 is shown, and includes a supply 252 of products, and control structure 254 coupled to each of the products. Product lessees using the system are required to perform tasks shown schematically at 256, and control structure 254 includes communication substructure 258 to afford communication between the product lessee and lessor about matters pertinent to the product lease, including monthly payment obligations by the lessee.

Still referring to FIG. 6, retail-product leasing system 250 also includes retail-lease structure 260 which may take the form of printed or electronic material that defines the lease relationship, and among other things, the number of tasks 256 that the lessee must perform to meet the obligations of retail-lease structure 260.

The specific embodiments of a method of allowing an owner to permit use of a product by a requestor regardless of creditworthiness as disclosed and illustrated herein are not to be considered in a limiting sense as numerous variations are possible. The subject matter of this disclosure includes all novel and non-obvious combinations and subcombinations of the various features, elements, functions and/or properties disclosed herein. No single feature, function, element or property of the disclosed embodiments is essential. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of the disclosure.

We claim:

1. A method of performing a product transaction where an owner permits a user to use a product without regard for the creditworthiness of the user, comprising:
providing the product to the user by requiring the user to perform at least one preselected task without any regard at any time for the creditworthiness of the user; and
preventing the user from using the product if the user does not perform the at least one preselected task.

2. The method of claim 1, wherein the preventing step is performed by using a product-control mechanism that allows the owner to remotely control the product if the user does not perform the at least one preselected task.

3. The method of claim 2, wherein the using substep is further characterized by using a product-control mechanism that allows the owner to block operation of the product by the requestor.

4. The method of claim 1, wherein the providing step involves requiring the user to agree to perform plural preselected tasks.

5. The method of claim 1, wherein the preventing step is performed by using a product-control mechanism that allows the owner to remotely control the product if the user does not perform the at least one preselected task.

6. The method of claim 5, wherein the using substep is further characterized by using a product-control mechanism that allows the owner to block operation of the product by the requestor.
